(19) United States
(12) Patent Application Publication
(10) Pub. No.: US 2026/0251130 A1
(43) Pub. Date: Aug. 27, 2026

(54) ROBOTIC DEVICE AND METHOD FOR OPERATING SAME

(71) Applicant: Cornell University, Ithaca, NY (US)

(72) Inventors: Yanxin Ji, Ithaca, NY (US); Paul McEuen, Ithaca, NY (US); Itai Cohen, Ithaca, NY (US); David Muller, Ithaca, NY (US)

(21) Appl. No.: 19/552,043

(22) Filed: Feb. 27, 2026

Related U.S. Application Data
(60) Provisional application No. 63/764,440, filed on Feb. 27, 2025.

(51) Int. Cl. F03G 7/06; H01H 1/06

(52) U.S. Cl. CPC F03G 7/0614; F03G 7/064; H01H 1/06

(57) ABSTRACT

A robotic device comprises an actuator hinge and a movable element connected thereto. The actuator hinge includes a bottom electrode, a top electrode, and a solid-state ionic material layer between the bottom and the top electrodes. A switch comprises a first element including a movable element. The movable element has a top thin-film electrode, a bottom thin-film electrode, and a solid-state ionic material layer between the top and the bottom thin-film electrode. In response to an applied first voltage, the first element changes shape from a first shape to a second shape. In response to an applied second voltage different from the first voltage, the first element changes from the second shape to the first shape. The switch is in a first state when the first element is configured in the first shape. The switch is in a second state when the first element is configured in the second shape.

### CROSS-REFERENCE TO RELATED APPLICATION

This application claims the benefit of U.S. Provisional Application No. 63/764,440, filed on 27 Feb. 2025, the disclosure of which is incorporated herein by reference in its entirety.

### GOVERNMENT RIGHTS

This invention was made with government support under 1719875 awarded by the National Science Foundation. The government has certain rights in the invention.

### BACKGROUND

Electronically driven actuators with micron-scale bending radii have enabled novel applications including robotic cilia, microscopic robots, and metamaterials. All low-power microactuators, however, require electrolyte environments for operation, ruling out application in air or vacuum.

### SUMMARY OF THE EMBODIMENTS

Embodiments disclosed herein include microactuators that overcome this limitation and demonstrate their promise for the most formidable of applications, sub-millimeter flying robots. These microactuators, which include atomically-thin solid-state ionic materials, are compatible with CMOS and operate in any environment: wet, dry, or vacuum. Embodiments of such microactuators achieve 20-μm bending radii, only consume ~1 μW, have high output power density (~1200 W/kg), and function at frequencies up to 5 kHz, all key requirements for achieving flight. Embodiments include actuators that have 250-μm flapping wings capable of resonant operation at ~530 Hz and a stroke angle of ~80° over an entire day, paving the way for sub-millimeter robotic fliers and many other applications in mechanical microsystems.

In a first aspect, a robotic device comprises an actuator hinge and a movable element connected thereto. The actuator hinge includes a bottom electrode, a top electrode, and a solid-state ionic material layer between the bottom electrode and the top electrode.

In a second aspect, a switch comprises a first element, which includes a movable element. The movable element has a top thin-film electrode, a bottom thin-film electrode, and a solid-state ionic material layer between the top thin-film electrode and the bottom thin-film electrode. In response to an applied first voltage, the first element changes shape from a first shape to a second shape. In response to an applied second voltage different from the applied first voltage, the first element changes shape from the second shape to the first shape. The switch is in a first state when the first element is configured in the first shape. The switch is in a second state when the first element is configured in the second shape.

### BRIEF DESCRIPTION OF THE FIGURES

FIGS. 1A-1E illustrate composition, structure, and basic operation of embodiments of solid-state ionic microscopic actuators (SIMAs) disclosed herein.

FIGS. 2A-2I illustrate underlying transport mechanisms and voltage-dependent behavior of SIMA embodiments.

FIG. 3A-3H are plots illustrating on-resonance behavior of a SIMA embodiment in vacuum.

FIGS. 4A-4K are schematics and graphs pertaining to embodiments of microscopic wings of a robotic device that includes a SIMA.

FIGS. 5A, 5B, and 5C depict a robotic device that includes a SIMA, in an embodiment.

FIG. 6 is a schematic of an embodiment of a switch, which is part of embodiments of robotic devices disclosed herein.

FIG. 7 is a functional block diagram of a circuit that includes one or more switches of FIG. 6, in an embodiment.

FIG. 8 is a flowchart illustrating a method for operating a robotic device of FIG. 5, in an embodiment.

### DETAILED DESCRIPTION OF THE EMBODIMENTS

### Introduction

Miniaturization of robotics holds tremendous potential for applications at the microscopic scale ranging from environmental monitoring, to biomedical diagnostics, and surgical interventions. Substantial progress has been made in miniaturizing robots to the centimeter scale. Such robots can locomote over various terrains [1-4], enable complex surgical procedures [5,6] and execute areal maneuvers in flight [7-9]. Shrinking such robots to the sub millimeter scale, however, has proved more challenging [10,11].

What are the barriers to engineering autonomous robots at this scale? Fifty years of Moore's law have already given us miniaturized electronics for information processing, storage, and communication [12,13]. Thus, the key limitation at the microscale has been materials for physical actuation that can convert voltage signals into action [11,14-16]. Many physical phenomena that convert electrical signals to forces do not scale to the nanometer sizes necessary to generate bending with micron scale radii of curvature, which limits how small such robots can be made.

Recently, progress has been made in fabricating such electronically driven microactuators [17-21]. For example, electrothermal actuators made of gold-polymer bimorphs were used to reversibly fold micro-origami machines [22]. Additionally, electrochemical actuators comprised of Pt—Ti bimorphs enabled bending with submicron radii of curvature to make micro-origami structures [17], artificial cilia [23], autonomous microscopic robots [24], and electronically controlled metamaterials [25].

Despite these remarkable achievements, however, microactuators developed thus far have severe limitations. Electrothermal actuators are highly inefficient and become more inefficient with miniaturization, while electrochemical actuators require an aqueous environment. They are not suitable for many applications, including enabling the most challenging form of locomotion: flight. For untethered flight, it is advantageous for electronic actuators to operate at low power, high frequency, small radii of curvature, and, most importantly, they must work in air over long periods of time. Here, we describe the development of a novel class of actuators, which we call solid-state ionic microscopic actuators (SIMAs), that satisfy these key requirements. As proof of concept, we design, fabricate, and test microscopic wings driven by SIMAs and demonstrate their suitability for sub-millimeter robotic fliers. We anticipate such actuators could also find micro-electromechanical applications in fields including sensing, medical robotics, and photonics.

### Solid-State Ionic Microscopic Actuators (SIMAs)

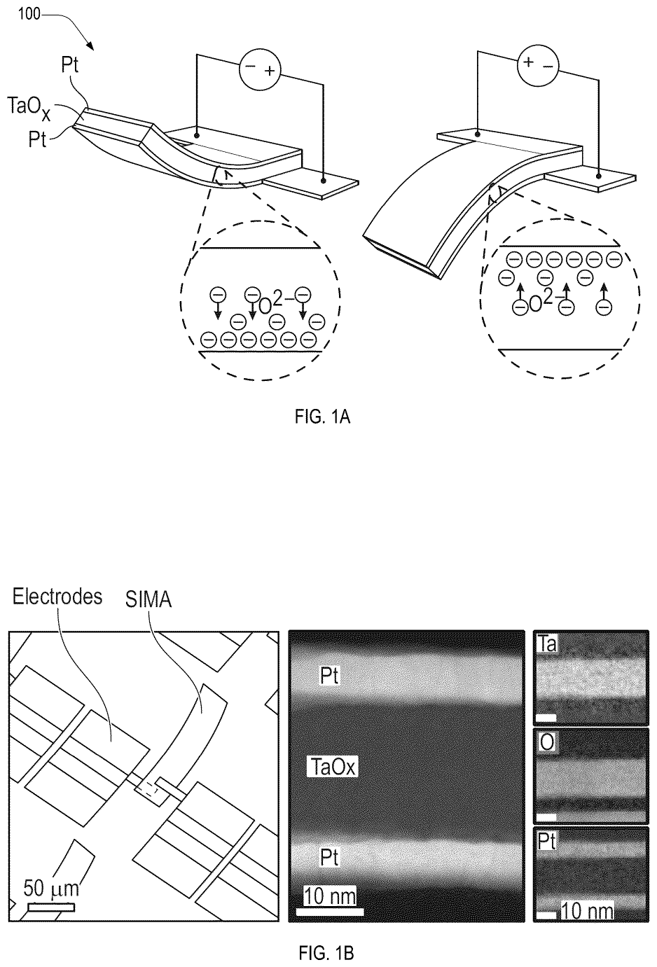

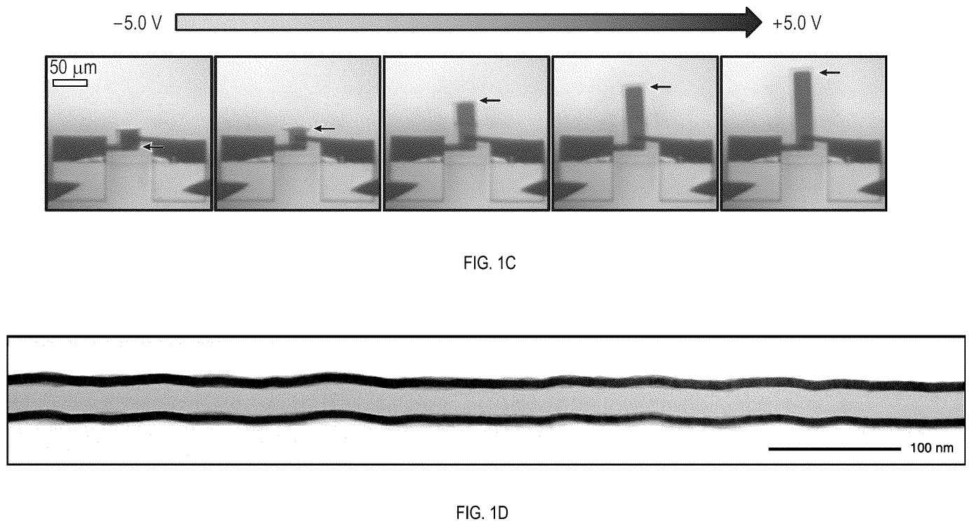

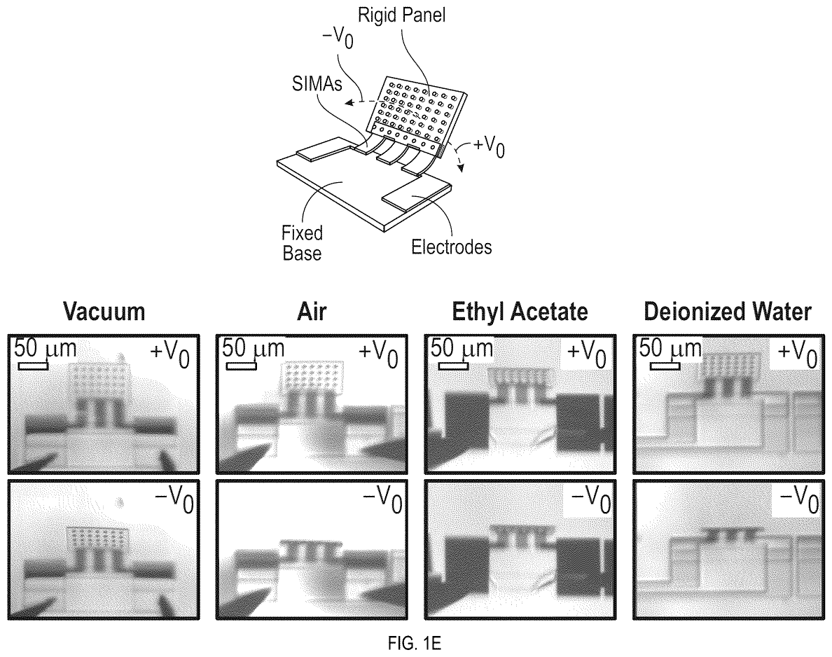

FIGS. 1A-1E illustrate composition, structure, and basic operation of embodiments of a SIMA 100. FIG. 1A is a schematic illustration of SIMA 100 that illustrates its operation mechanism. FIG. 1B is line drawing based on a SEM image of an example of SIMA 100 after release and a HADDF-STEM image showing a cross-section of SIMA 100: a 20 nm TaOₓ layer capped by 6 nm Pt on both top and bottom with EELS elemental maps.

FIG. 1C shows examples of SIMAs 100 bending under an applied voltage shift. The dark red arrows label the actuator tip positions. FIG. 1D is a 700 nm-long HAADF-STEM cross-section demonstrating the uniformity of the film of SIMA 100. FIG. 1D schematic illustration and optical micrographs showing examples of SIMA 100 operating in vacuum, air, ethyl acetate, and deionized water under ±5 V. In each microactuator, the SIMAs serve as hinges between the surface and the rigid panel.

The key to fabricating actuators that work in any environment is to internalize the mechanism for actuation, in our case, ionic charge transport. Toward this end, embodiments of SIMA 100 include a 15-20 nm oxide (TaOₓ) layer sandwiched between two 7-nm metal (Pt) layers (FIG. 1A, B). Actuation relies on redistributing oxygen ions to induce stress gradients that bend the microactuator (FIG. 1A). A line drawing based on an SEM image of an example SIMA 100 is shown in FIG. 1B. A HAADF-STEM image of the microactuator cross-section along with EELS images confirming layer compositions are shown in FIG. 1B middle and right, respectively. When voltage is applied across the oxide, ions migrate to create oxygen-rich regions that expand and oxygen-deficient regions that contract by about 0.17%. The induced stress mismatch bends the device with a curvature change up to 0.05 μm⁻¹ (FIG. 1C).

The operation principle of a SIMA architecture is distinct from that of resistive random access memory (RRAM) devices. For example, RRAM relies on filament formation between the electrodes, while the microactuators cease to operate once filaments are formed. To avoid filament formation, we use an ALD fabrication process that produces an amorphous oxide film of uniform thickness (FIG. 1D, E). The amorphous film provides evenly distributed defects that promote oxygen ionization and migration while preventing conductive filament formation along grain boundaries [26,27]. The high uniformity also mitigates the risk of filament formation caused by thickness irregularities [28]. Critically, since the charged particle transport occurs within the device, the microactuator can function in both dry (vacuum and air) and wet (organic solvents and aqueous solutions) environments (FIG. 1E).

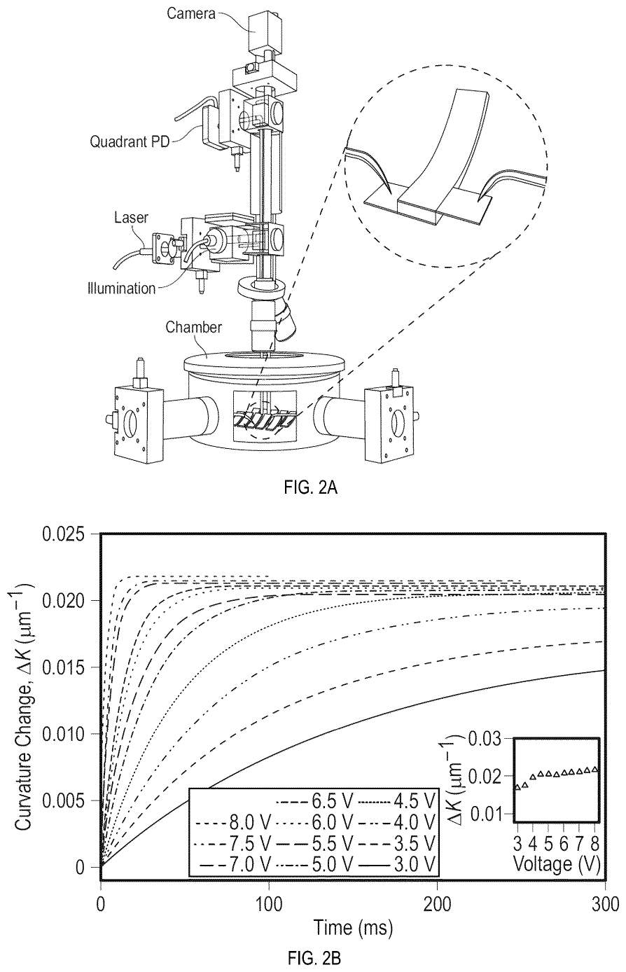

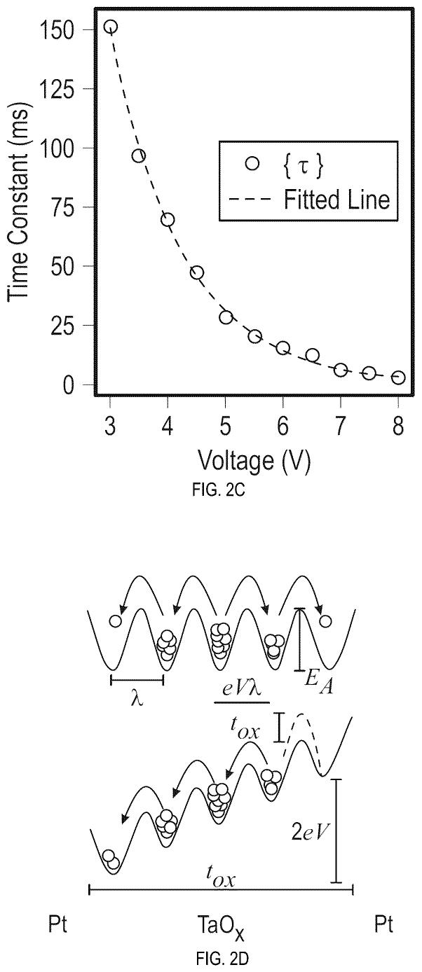

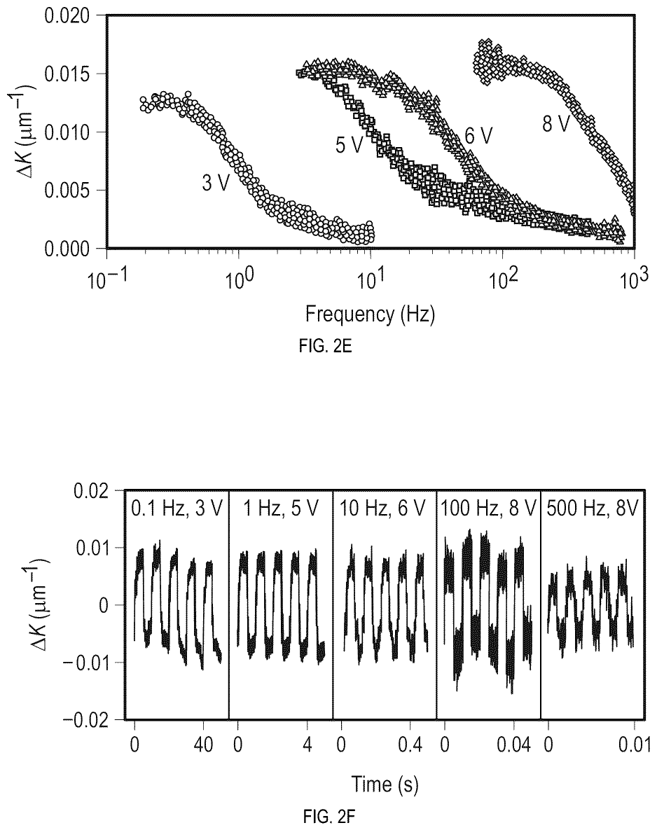

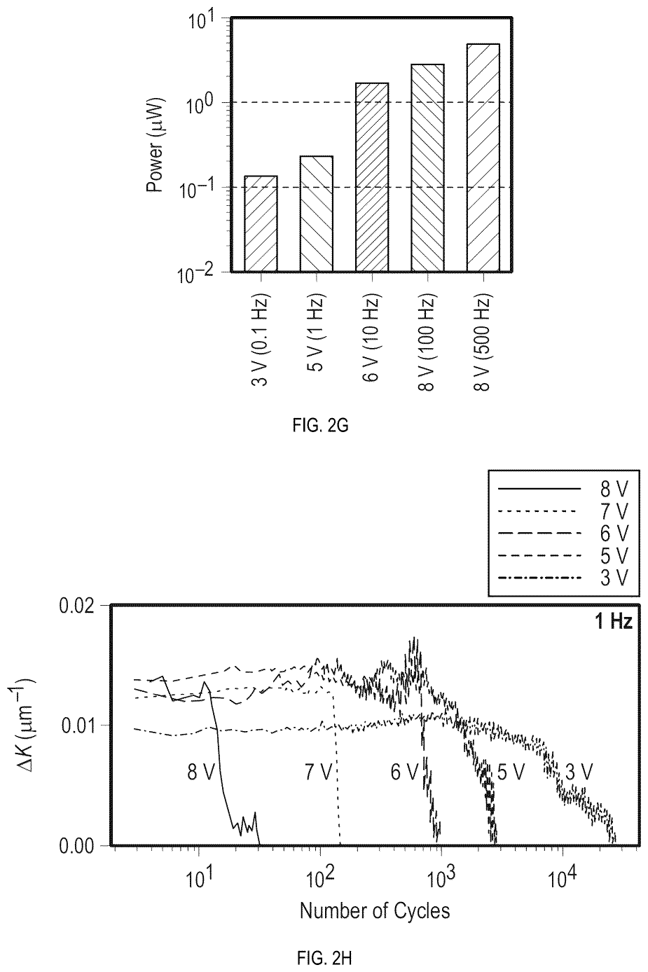

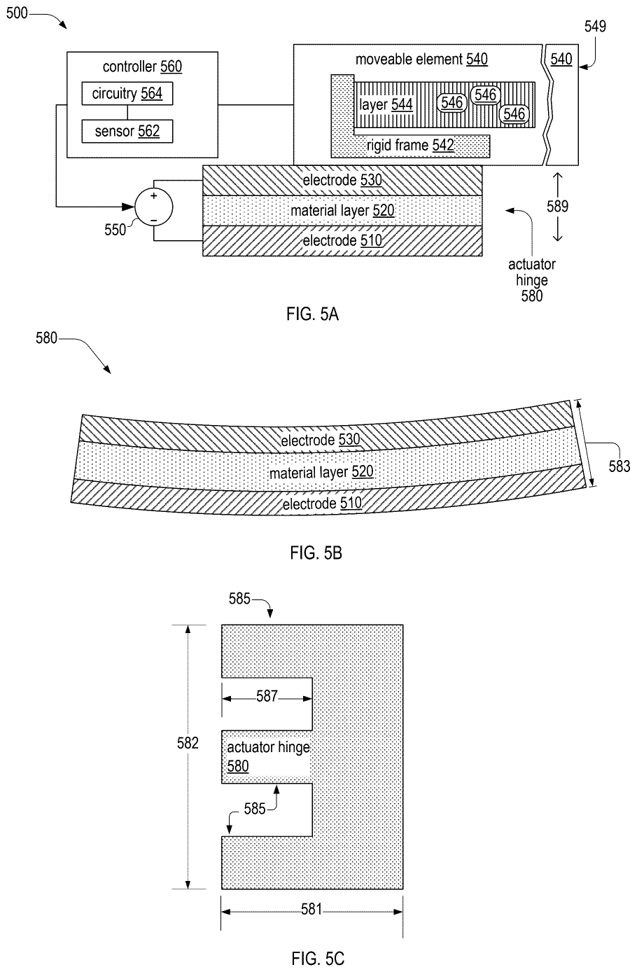

FIGS. 2A-2I illustrate underlying transport mechanisms and voltage-dependent behavior of SIMA embodiments, which are examples of actuator hinge 580 shown in FIG. 5. FIG. 2A is a schematic of the measurement apparatus, which includes a camera, a quadrant photo detector, a laser, and micro manipulators. FIG. 2B is a plot of curvature change, Δκ versus time for step voltage increases with amplitudes ranging from ±3 V to ±8 V; The inset shows fitted saturation amplitude for Δκ versus voltage. FIG. 2C is a plot of fitted response time τ from FIG. 2B as functions of voltage. FIG. 2D is a schematic of ion migration in a corrugated potential with a hopping distance of λ. To hop from one well to another, ions must overcome a potential barrier. As a voltage is applied across the oxide, this potential tilts and the effective overpotential decreases by eVλ/tₒₓ where e is the electron charge and tₒₓ is the oxide thickness.

FIG. 2E is a plot of curvature change Δκ versus driving frequency at different applied square wave voltages (±3 V to ±8 V). For each voltage, the actuation amplitude starts to decrease when the time scale associated with driving is smaller than the relaxation time shown in (C). FIG. 2F is a plot of curvature change Δκ for an actuator operating at low voltage for low-frequency operation and at high voltage for high-frequency operation, while maintaining similar changes in bending curvature. The curvature change is plotted after mean subtraction.

FIG. 2G is a plot showing power consumption under different driving voltages. FIG. 2H is a plot of curvature change Δκ versus the number of actuation cycles at different applied step voltages (±3 V to ±8 V) with a frequency of 1 Hz. FIG. 2I is a plot of curvature change Δκ versus the number of actuation cycles at different operation frequencies (1 Hz to 500 Hz) with an applied voltage of ±8 V.

To investigate the ion migration mechanism driving actuation, we measured the microactuator deflection versus time under various applied voltages. Devices were placed in a pressure-adjustable vacuum chamber with a glass window. Using a laser beam directed at the actuator and a quadrant photodetector, we measured deflections caused by the actuation (FIG. 2A). Time domain data were recorded using an oscilloscope. Frequency domain spectra were obtained via Fast Fourier Transform of the deflection data. We measured the transient actuation in response to step voltages ranging from 3 V to 8 V (FIG. 2B). We found that the curvature saturation values are nearly independent of voltage (FIG. 2B inset). The time dependence was well fit using exponential functions with time constants r that decreased with increasing voltage (FIG. 2C). This trend can be understood as arising primarily from ion drift under a high electric field (FIG. 2D). To model this process we use a modified Nerst-Einstein equation [29]:

$$τ ( V ) = \frac{1}{sinh ( \frac{\vert Z \vert eV λ}{2 {t}_{ox} kT} )} \frac{3 {t}_{ox}}{λ v} {e}^{\frac{{E}_{A}}{k T}}$$

where Z is the charge number (−2 for oxygen ions), V is the applied voltage, tₒₓ is the oxide thickness (15 nm), ν is the oxygen vibration frequency (2×10¹³ Hz) [30], λ is the oxygen ion hopping distance, and E_{A} is the ion migration barrier. By fitting τ as a function of V (dashed orange line in FIG. 2C), we extract a hopping distance of 3.04 Å and a migration barrier of 0.66 eV. These values are in good agreement with previously reported oxygen-ion transport parameters in tantalum oxide (λ~4.7 ∈ [31], E_{A}~0.8 eV [32,33]). Drift under a potential can drive relatively fast actuation. For example, at high voltages (≥7 V), the actuator response time is only a few milliseconds, outperforming most electrothermal actuators, ionic polymer actuators, and dielectric elastomer actuators.

To determine the suitability of the microactuator to applications such as flapping flight, we tested its performance under cyclic operation. We found that when driven by a square wave oscillating voltage, the amplitude dramatically decreased beyond a voltage-dependent cutoff frequency that is proportional to 1/τ (FIG. 2E). Furthermore, we found that while higher voltage is beneficial for faster actuation, it also resulted in increased power consumption, primarily due to leakage current. Thus, to optimize energy efficiency, one can operate the actuator at low voltage for low-frequency applications and at high voltage for high-frequency applications, while still maintaining the same bending amplitude (FIG. 2F, G).

An additional important parameter is the microactuator durability. Measurements of the actuation amplitude versus number of cycles to failure indicate that the durability is highly dependent on the voltage and frequency. For example, at 1 Hz, actuators driven at 8 V only last ~10 cycles while actuators driven at 3 V can last tens of thousands of cycles (~3 hours) (FIG. 2H). We also find that for a driving magnitude of 8 V, the durability increases from 10 cycles when actuated at 1 Hz to ~100,000 cycles when actuated at 500 Hz (FIG. 2I).

These trends can be understood by recognizing that failure likely arises from the formation of filaments between the two electrodes [34]. When ions drift lengths are short, it is more difficult to form a filament that shorts the device. Since ion drift is shortened by both decreasing the voltage for a given driving frequency or by increasing the frequency for a given driving voltage, in both scenarios the actuator longevity increases. Unfortunately, this increased durability for low voltages and high frequencies is coupled with a decrease in actuation amplitude (FIGS. 2H,I). Thus, at first glance, it might seem that despite having impressive properties, these actuators, even in the best cases, are not suitable for flapping flight applications—which require large actuation amplitudes at high frequency (~100 Hz) over a time scale of hours to days.

For SIMAs, the idea is to drive the microactuator at very high frequencies so that ions cannot migrate far, which limits transport, inhibits filament formation, and enhances actuator longevity. Normally, limited transport also results in a small actuation amplitude. At resonance, however, even a small driving amplitude induced by limited ion migration can generate large oscillations of the entire device.

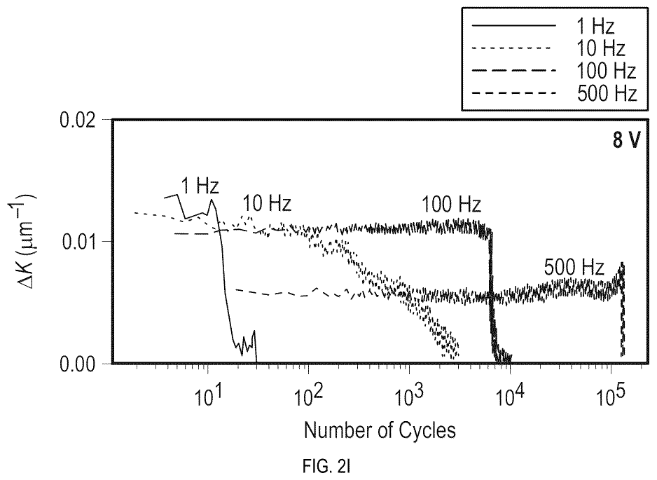

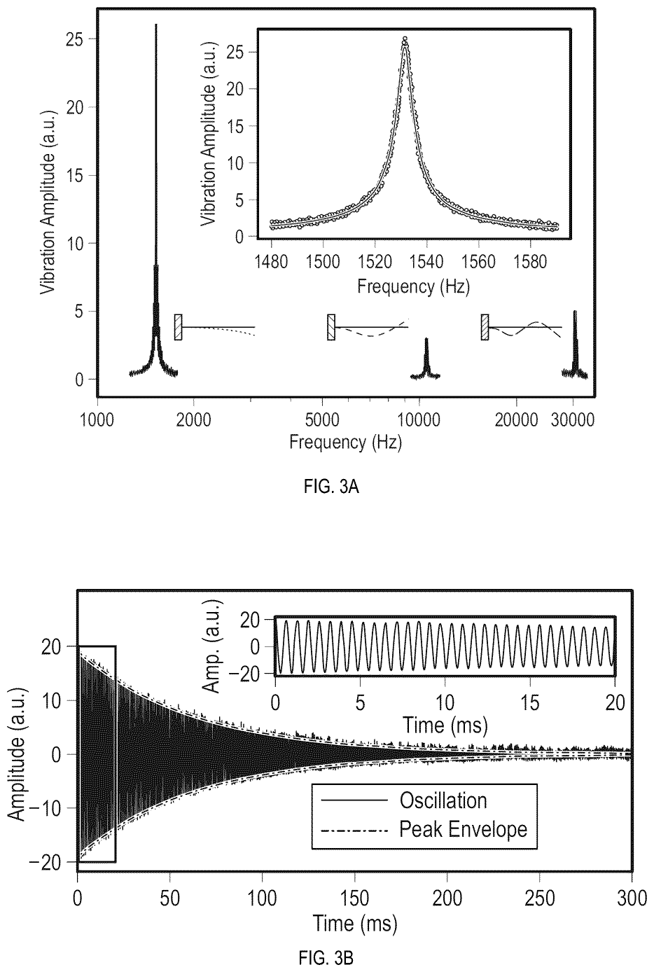

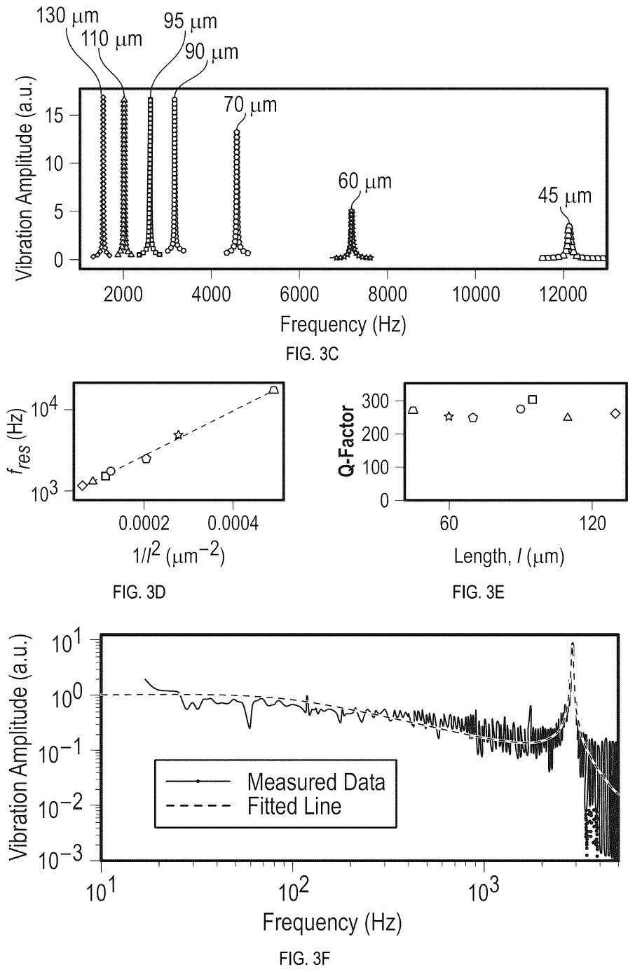

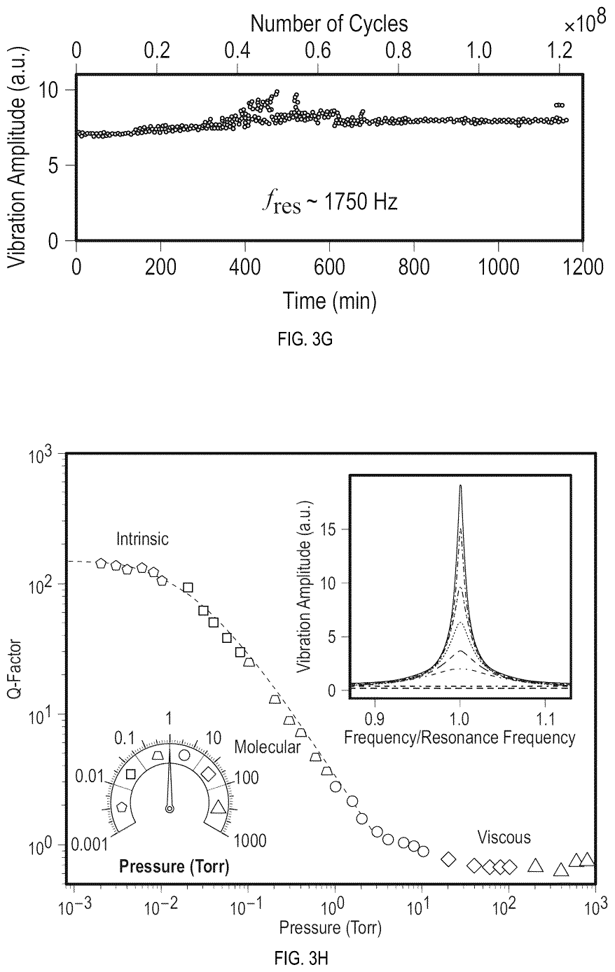

FIG. 3A-3H are plots illustrating on-resonance behavior, in vacuum, of a SIMA embodiment, which is an example of actuator hinge 580, FIG. 5. FIG. 3A is a plot of measured resonance peaks corresponding to different vibration modes (associated schematics). The inset highlights the most prominent resonance at ~1532 Hz. The vibration amplitude was determined from a quadrant photodiode signal. FIG. 3B is a plot of vibration amplitude versus time showing the damped oscillation immediately after the driving voltage is removed; the inset shows several oscillation cycles corresponding to the pink outlined region in the main plot. FIG. 3C is a plot of resonance peaks corresponding to the first vibration mode for actuators of different lengths.

FIG. 3D is a plot of the resonance frequency (fᵣₑₛ) for the first vibration mode versus the inverse square of the actuator length. FIG. 3E is a plot of Q-factor versus actuator length (l). FIG. 3F is a plot of vibration amplitude for a broad range of driving frequencies (20 Hz-5000 Hz) indicating that the amplitude at resonance is even larger than at low frequencies. FIG. 3G is a plot of actuation amplitude over time and across multiple cycles when operating at approximately the resonance frequency (~1750 Hz for this actuator). FIG. 3H is a plot of Q-factor dependence on pressure spanning the range 1 mTorr to atmospheric pressure.

Operating at resonance requires understanding the damping and inertial contributions to the device oscillations. To investigate resonance in SIMAs, we pumped down the vacuum chamber to ~1 mTorr to create a low-damping environment. We observed multiple resonances corresponding to different cantilever vibration modes (FIG. 3A). The most prominent resonance was at ~1532 Hz, which we associate with the fundamental vibration mode. We also observed two secondary resonance peaks at ~10,600 Hz and ~30,600 Hz, which we attribute to the two-node and three-node cantilever vibration modes, respectively. By fitting the primary resonance peak (orange curve in FIG. 3A inset), we determined a Q-factor of ~266. We also measured the damped oscillation immediately after removing the driving voltage (FIG. 3B). From the exponential fit to the amplitude decay envelope, we extract a decay time constant of ~63 ms corresponding to a Q-factor of ~303. This value is consistent with the Q-factor obtained directly from the resonance peak.

We find that the primary resonance is well described by Euler-Bernoulli beam theory, where the resonant frequency for a cantilever is given by:

$${f}_{n} = \frac{{K}_{n}^{2} h}{2 π {l}^{2}} \sqrt{\frac{E}{12 ρ}} ,$$

where Kₙ is a constant that depends on the vibration mode (1.875 for K₁), h is the cantilever thickness, l is the cantilever length, E is the Young's modulus and ρ is the mass density [36]. In particular, measurement of the resonance peaks for different actuator lengths (FIG. 3C) confirm that the resonant frequencies scale as l₋₂ (FIG. 3D). We estimate the actuator's Young's modulus from the slope of a linear fit to the data in FIG. 3D. We extract a modulus of ~255 GPa, which is in reasonable agreement with the Young's modulus of Pt (~170 GPa) and the Young's modulus of TaOₓ (~140-380 GPa [37]). In addition, we find that the Q factors are nearly independent of the device length (FIG. 3E).

To test whether operation at resonance does indeed enable microactuator operation at large amplitude for extend periods of time, we drive the actuator at 7 V over a wide frequency range (20 Hz-5000 Hz) (FIG. 3F). We find that the actuator amplitude at resonance is larger than it is at low frequencies. In addition, when operated at resonance, the vibration amplitude is sustained with no degradation for over 108 oscillations or 20 hours, at which point the experiment was stopped (FIG. 3G).

To determine how operation at resonance is influenced by air, we measured the Q-factor dependence on air pressure (FIG. 3H). we observed three regimes, each associated with a different energy loss mechanism: intrinsic damping, molecular damping, and viscous damping [38]. In the low-pressure regime, the Q-factor is constant, reflecting the intrinsic damping associated with the cantilever. As the pressure P, increases into the intermediate regime, environmental damping becomes important. Here, the actuator interacts with individual air molecules, exchanging momentum at a rate proportional to their relative velocity.

The measured Q-factors fit well to the analytic model

$$Q = 93 \frac{\sqrt{E ρ}}{P} {( \frac{h}{l} )}^{2}$$

derived in [39] (dashed line in FIG. 3H). At high pressures, air behaves as a viscous fluid. In this regime, the quality factor is approximately twice that predicted by theory

$$Q = \frac{\sqrt{E ρ} w}{24 μ} {( \frac{h}{l} )}^{2} ,$$

where μ is the air's dynamic viscosity, and w is the cantilever width [38].

Since the air viscosity remains relatively constant with pressure in this regime, the Q-factor does not change significantly. We speculate the factor of 2 difference arises from compression of the air between the cantilever and the surface beneath. Although as shown in FIG. 3H inset, the resonance dramatically decreases as air is introduced, it is important to note that resonance arises from both damping and the inertia of the oscillator. Thus, by properly designing the total mass and its distribution in our device, it should be possible to recover higher Q-factors in air. In essence, we need to build a wing.

At its core, a wing is simply a panel attached to a driven hinge and its Q-factor and resonance frequency may be adjusted by varying the wing mass, wing shape and hinge properties. Guided by the second-order harmonic equation described in [40], we built a simplified resonator made of a three-bar SIMA flapping a square rigid panel (a 2 μm-thick nLOF™ photoresist layer and a 400-nm-thick Pt layer, with dimensions of 200 μm×200 μm). By adjusting the actuator length, we obtained resonances with Q-factors greater than ten, surpassing those reported for even the highest-performing natural insect wings [41].

Building on these results, we took on the challenge of developing microscopic wings for sub-millimeter flapping robots. Increasing the wing mass and incorporating a passive hinge at the leading edge to allow wing pitch, we constructed a rudimentary wing with a ~250 μm wing span and a ~150 μm chord length.

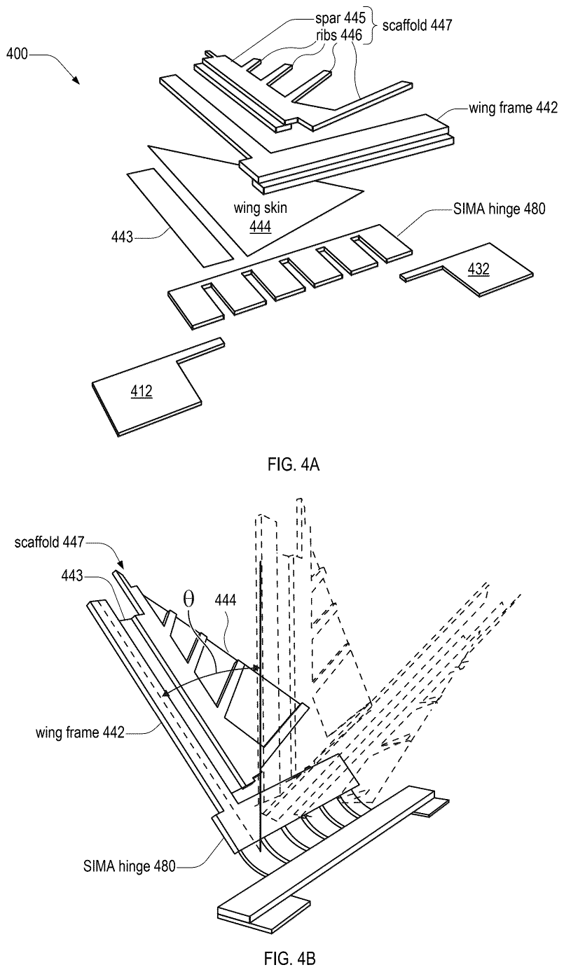

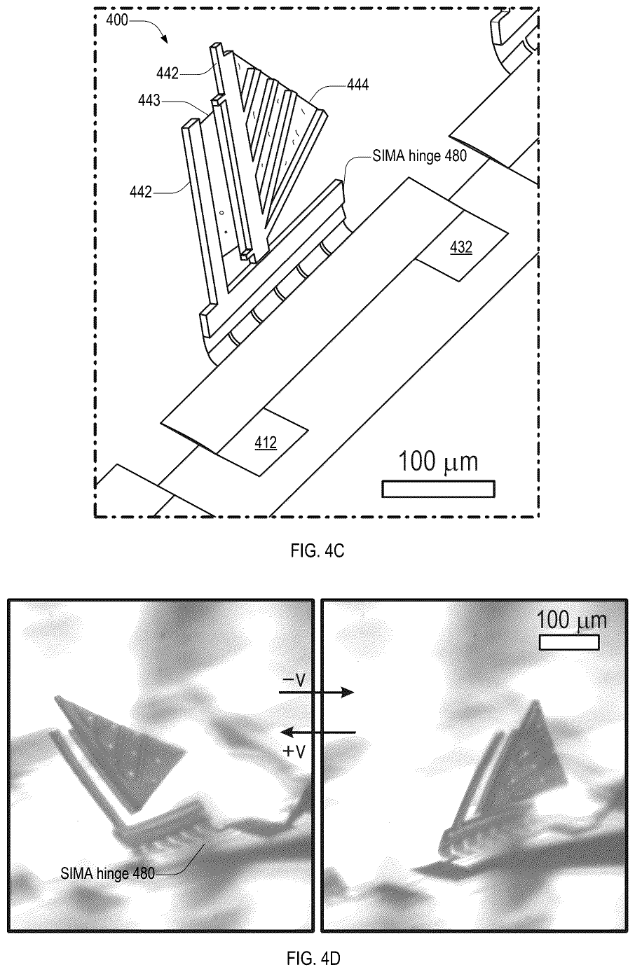

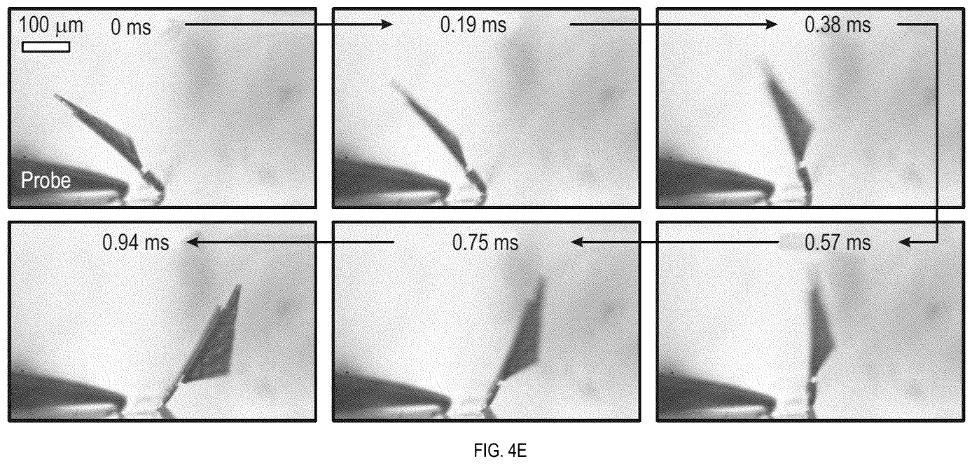

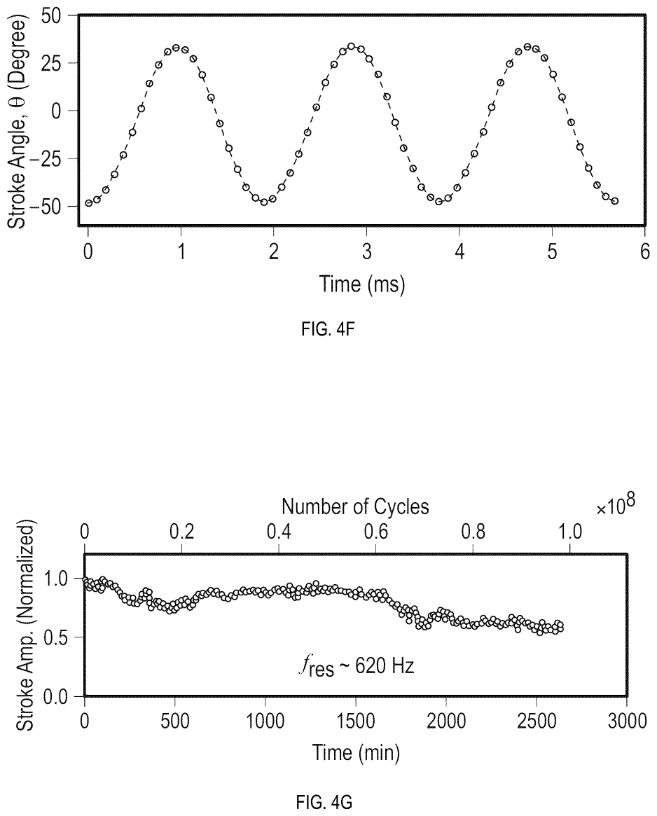

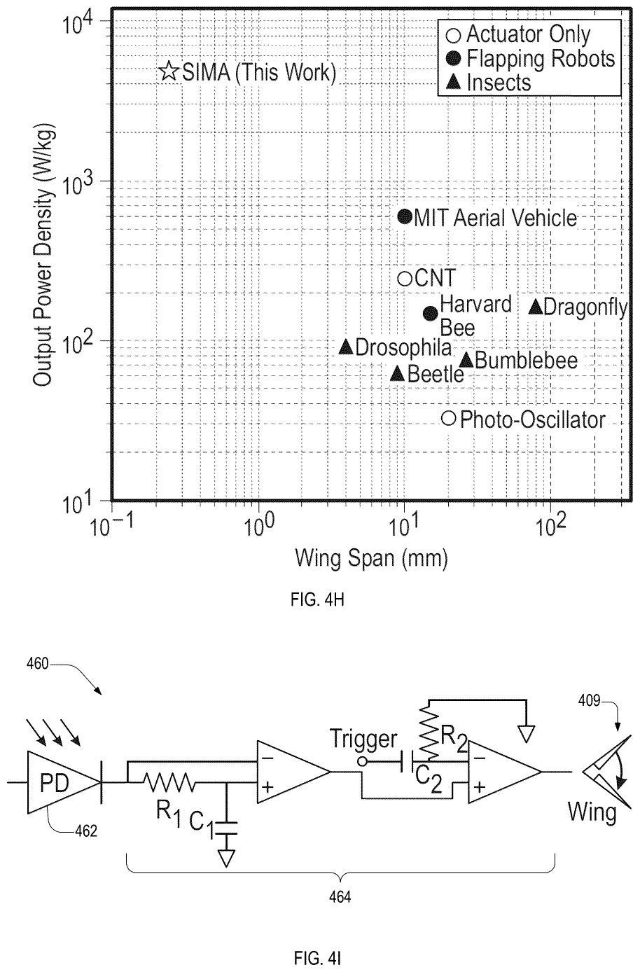

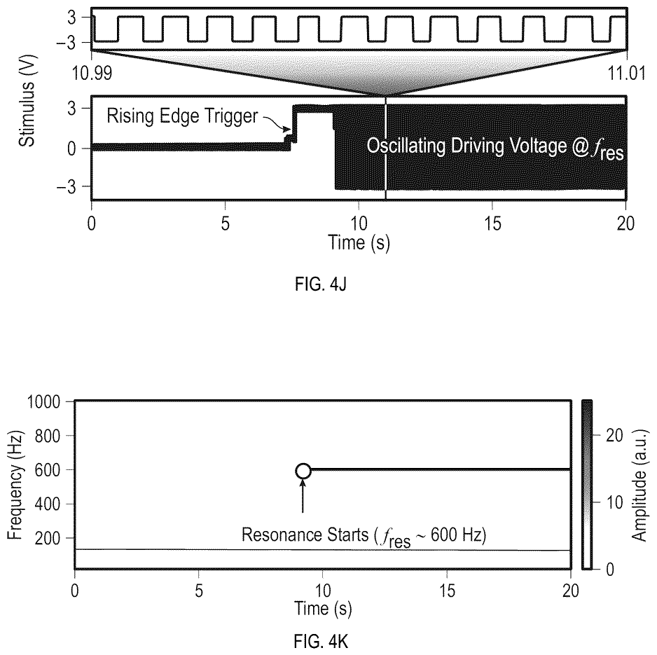

FIGS. 4A-4K are schematics and graphs pertaining to embodiments of said microscopic wings. FIG. 4A is an exploded schematic of an embodiment of a sub-mm flapping wing 400. Flapping wing 400 includes a wing frame 442, a passive hinge 443, a scaffold 447, a SIMA hinge 480, and electrical contacts 412 and 432. FIG. 4A also denotes a wing skin 444. Scaffold 447 includes a spar 445 and multiple ribs 446.

FIG. 4B is a schematic illustrating the wing motion and defining the stroke angle θ between wing plane 402 and the z-axis. FIG. 4C is a line drawing based on an SEM image of flapping wing 400. FIG. 4D is a pair of microscopic optical images showing an embodiment of flapping wing 400 in the forward and backward configurations associated with the positive and negative applied voltage. FIG. 4E is a sequence of images showing an embodiment of flapping wing 400 operating at its resonance frequency (~530 Hz). FIG. 4F is a plot of tracked wing stroke motion. FIG. 4G is a plot of stroke amplitude over time and across multiple cycles at the resonance frequency (~620 Hz). The amplitude is normalized by dividing it by the initial amplitude.

FIG. 4H is a plot showing output power density performance of robotic flapping-wing actuators and insect flight muscles [7,9,45-50]. FIG. 4I is a circuit diagram illustrating a robotic controller 460 designed to drive a wing 409 at the resonance frequency after receiving a trigger. Robotic controller 460 includes a photodiode 462 and circuitry 464. Flapping wing 400 is an example of wing 409.

In FIG. 4J, the lower plot illustrates the rising-edge trigger that initiates oscillation and begins driving the wing at fᵣₑₛ, while the upper plot shows several oscillation cycles corresponding to the period outlined. FIG. 4K is a plot of a wavelet transform of the wing actuation time trace, revealing resonance onset at approximately 600 Hz after the trigger, with amplitude increasing sharply at that frequency.

Each wing includes Pt/Ti electrodes that drive SIMAs, a passive hinge made of TaOₓ, a wing panel made of Ti, a ~2 μm layer of nLOF™ photoresist and a ~7-μm SU-8 wing frame (FIG. 4A). A schematic illustrating the wing motion and defining the stroke angle between the wing plane and the z-axis, θ, is shown in FIG. 4B. By switching the voltage from positive to negative, we can drive the wing back and forth (FIG. 4D). Finally, when this driving voltage is applied at resonance (530 Hz), we achieved continuous flapping (FIG. 4F). We plot the stroke angle versus time in FIG. 4F, and determine that the wing stroke amplitude is ~80°. To assess wing durability, we monitored the stroke amplitude of another wing from the same fabrication batch over time. The stroke amplitude remains large for about 10⁸ cycles or −1 day (FIG. 4G), demonstrating that operating at resonance effectively preserves wing performance over extended periods.

An important measure often used to evaluate wing actuators is the output power density, or the mechanical output power generated by the wing divided by the microactuator mass. Given an actuator length of 15 μm, an actuator density of 13,000 kg/m³, an operation frequency 530 Hz and a stroke angle of 80°, we calculate SIMA's output power density to be ~1200 W/kg. This performance is on par with that of all known insect flight muscles and actuators used in miniaturized robotic fliers at larger scales (FIG. 4H).

Finally, another major advantage of SIMAs is their capacity for integration with CMOS electronics. SIMAs are fabricated using standard CMOS-compatible processes and can be driven by typical CMOS supply voltages (3-5 V), enabling programmable control. Such circuits could be designed to power the wing at resonance. To demonstrate this capability, we implemented the circuit shown in FIG. 4I. In our setup, a photodetector (PD) monitors the sub-mm wing's oscillation, and its output signal is fed into a phase lock-in circuit with amplifiers that boost the signal in the feedback loop. A rising edge trigger is applied to initiate the oscillations. Once the supplies are turned on, the circuit locks onto the resonant frequency in ~2 s and sustains the driving voltage (FIG. 4J), which in turn drives the wing to beat at resonance (FIG. 4K). Miniaturization of such circuits to the 100 μm scale is trivial. Moreover, slightly detuning the wings from resonance could enable differential operation, providing steering control.

### DISCUSSION

While our analysis of this exciting technology has focused on flight, SIMAs could be important for numerous applications. At medium to low frequencies (0.1-10 Hz), SIMAs can operate reliably in any environment, can exhibit micron-scale bending radii, have a durability (several thousand cycles) that matches or exceeds most microactuators, all while consuming very little power (~1 μW) (FIG. 2G). These characteristics enable SIMAs to, for example, serve as legs for amphibious microscopic robots. Operation at resonance would support vibration-based locomotion for legged robots, enabling rapid movement and improved adaptability across uneven terrain. SIMAs could also function as vibratory gyroscopes, analogous to the halteres of Diptera, bringing detection of rotational motion to microscale devices. Finally, we can easily imagine SIMAs as an enabling technology for a variety of medical robots ranging from micro-valves for fluid transport, to microactuators that enable indentation for non-invasive characterization of soft tissues.

The most remarkable potential for applying this technology, however, resides in realizing untethered sub-mm flying robots. Over the past two decades, significant progress was made in creating such robots including RoboBee, which has a wingspan of L~50 mm [7,8] and rotary drones such as Piccolissimo that have reached even smaller sizes of L~20 mm [42]. These systems, however, frequently rely on batteries and struggle with extended flight durations when untethered.

One strategy to increase flight longevity is to further reduce the size of these robots so they may be fully powered by solar energy. Miniaturization does, however, add additional constraints. According to scaling laws relevant to flapping-wing flight, the lift force F~L²U², where L is the length scale of the robot and U is the wing velocity, whereas the mass scales as L³. Using U~Lf where f is the frequency, and setting the lift equal to the weight, the frequency scales as f~L^{-0.5} [43]. In other words, the smaller the flapper the higher the flapping frequency necessary to maintain flight.

To evaluate the theoretical performance limits of these wings, we simulated lift force under optimized kinematic conditions (a maximal pitch angle of 45°). While experimental demonstrations in this work characterize the extrema of 0° and 90° pitch, an intermediate 450 rotation could be attained by precisely tuning the torsional stiffness of the passive hinge. Both a quasisteady aerodynamic analysis and computational fluid dynamics simulations of our wings (wing span of 250 μm) under optimal kinematics indicate that four of them, operating at a stroke amplitude of 80° and a beat frequency of 530 Hz (like the wing shown in FIGS. 4E,F), would produce a total lift of ~16 nN. This force is sufficient to support a ~6.4 nN payload, which accounts for a 50 μm by 50 μm by 15 μm CMOS circuit [24] (~0.9 nN), the weight of four wings (~4 nN), and 22500 μm² by 3 μm silicon photovoltaics (generating ~4 μW under 1 sun, ~1.5 nN). Furthermore, during the critical takeoff phase, the effective lift force is expected to be higher due to ground effects as the wings operate in close proximity to the surface. Thus our robotic wings could meet the frequency criteria established by the lift to weight balance.

The second constraint is on the power needed to drive the actuators. Here, smaller scales are an advantage since mechanical power, P=FU, scales as ~L^{3.5} [44]. Consequently, sufficiently decreasing the robot's dimensions would make it possible to power it with less than one sun (1 mW/mm²). Indeed, we estimate that for a 22500-μm² photovoltaic with an efficiency of 20% we can generate ~4 μW while the power consumption from each actuator is ~1 μW. Thus, at this scale our actuators could produce enough lift while being fully powered by on board photovoltaics under the illumination of one sun. Collectively, these capabilities position SIMAs as a key technology for advancing the mastery of flapping flight to the sub-millimeter scale.

FIG. 5A is a functional block diagram of a robotic device 500, which includes an actuator hinge 580 and a movable element 540 connected to actuator hinge 580. FIGS. 5B and 5C are a schematic cross-sectional view, and a plan view, respectively of actuator hinge 580. FIGS. 5A-5C are best viewed together in the following description.

Flapping wing 400, FIGS. 4A and 4B, is an example of robotic device 500, where wing frame 442, wing skin 444, and SIMA hinge 480 are respective examples of rigid frame 542, layer 544, and actuator hinge 580.

Actuator hinge 580 includes an electrode 510, an electrode 530, and a material layer 520 between electrodes 510 and 530 along an axis 589, which is a surface-normal to material layer 520. Robotic device 500 may be a robotic flier or a terrestrial robot. Movable element 540 may be a wing, and may be configured to have oscillatory motion, e.g., under resonance operation. Each of electrodes 510 and 530 may be a thin-film layer. In SIMA 100, FIG. 1A, the Pt layers are examples of electrodes 510 and 530, while the TaOₓ layer is an example of material layer 520.

Actuator hinge 580 has a length 581, a width 582, and a thickness 583. Length 581 and width 582 may be between 10 μm and 1 mm. Thickness 583 may be between 10 nm and 10 μm. In embodiments, a thickness of one or more of electrodes 510, material layer 520, and electrode 530 is less than 100 nm, which is advantageous for achieving small bending radii of curvature, e.g., at the micron-scale. Actuator hinge 580 may have one or more protrusions 585 each having a length 587. In the example shown in FIG. 5B, actuator hinge 580 has three protrusions 585 such that actuator hinge 580 is E-shaped. Length 587 may equal zero such, for example, when actuator hinge 580 is rectangular in the plan view of FIG. 5C.

Material layer may be a solid-state ionic material layer. A material composition of the material layer 520 may includes one of a transition metal oxide, a complex oxide, a lithium-based solid electrolyte, silver iodide, beta-alumina, rubidium silver oxide, calcium fluoride, halide-ion conductor, sodium-ion conductor, perovskite-based ionic material, or any combination thereof. The transition metal oxide includes one of TaOₓ, HfOₓ, TiOₓ, CuOₓ, ZrOₓ, SiOₓ, AlOₓ, VOₓ, WOₓ, or any combination thereof. A material composition of each of electrode 510 and 530 may be the same, may differ, and may include one of platinum, palladium, gold, titanium, aluminum, tantalum, chromium, nickel, copper, iron, cobalt, silver, iridium, ruthenium, molybdenum, an alloy, a conductive oxide, or any combination thereof.

Actuator hinge 580 may be configured to drive movable element 540 at its resonance frequency for a number N cycles with degradation less than a percentage P. The number of cycles N may exceed 10⁶, 10⁷, 10⁸, or 10⁹. Example values of percentage P include 10%, 20%, 30%, 40%, and 50%. Movable element 540 has a distal end 549 that actuator hinge 580 can control to displace in a direction parallel to axis 589. A magnitude of this displacement may be on the order of a few millimeters, for example, between 2 mm and 9 mm.

Robotic device 500 may include either or both of a power source 550 and a controller 560. Robotic controller 460, FIG. 4I, is an example of controller 560. In embodiments, power source 550 supplies a voltage across material layer 520, which causes actuator hinge 580 to bend as illustrated in FIG. 5B. In embodiments, the voltage supplied by power source 550 induces a curvature change Δκ of actuator hinge 580 that is up to 0.05 μm⁻¹. For example, the curvature change Δκ may be between 0.01 μm⁻¹ and 0.05 μm⁻¹. The voltage magnitude may be between 0.1 V and 10 V, for example, between 3 V and 10 V.

In embodiments, power source 550 includes a photovoltaic array, a surface area of which may be between 100 μm² and 1 mm². Controller 560 includes circuitry configured find a resonant frequency of movable element 540 and/or to control movable element 540. Controller 560 may be communicatively coupled to power source 550 and may control power source 550.

Controller 560 may include a sensor 562 and circuitry 564 that receives a measured signal from sensor 562. Photodiode 462 and circuitry 464 of controller 460, FIG. 4I, are respective examples of sensor 562 and circuitry 564. In embodiments, circuitry 564 outputs a control signal based on the measured signal, and actuator hinge 580 adjusts operations and/or motions of movable element 540 based on the control signal.

In embodiments, movable element 540 includes one or both of a loading layer 544 and a rigid frame 542. Loading layer 544 may be connected to and/or on rigid frame 542. Loading layer 544 may be a flexible layer and may include a plurality of mass loads 546 embedded therein. Along axis 589, a thickness of each mass load 546 may be between 100 nm and 1 μm, while a thickness of loading layer 544 may be between 1 nm and 50 nm or between 50 nm and 5 μm.

In embodiments, one or more of movable element 540, rigid frame 542, and loading layer 544 comprises one or more organic materials (e.g., polymer, wood, etc.), one or more inorganic materials (e.g., metal, metal oxide, glass, etc.), one or more hybrid organic and inorganic materials, or any combination thereof. Rigid frame 542 may be formed of a polymer. The material composition of loading layer 544 and/or mass loads 546 may include platinum.

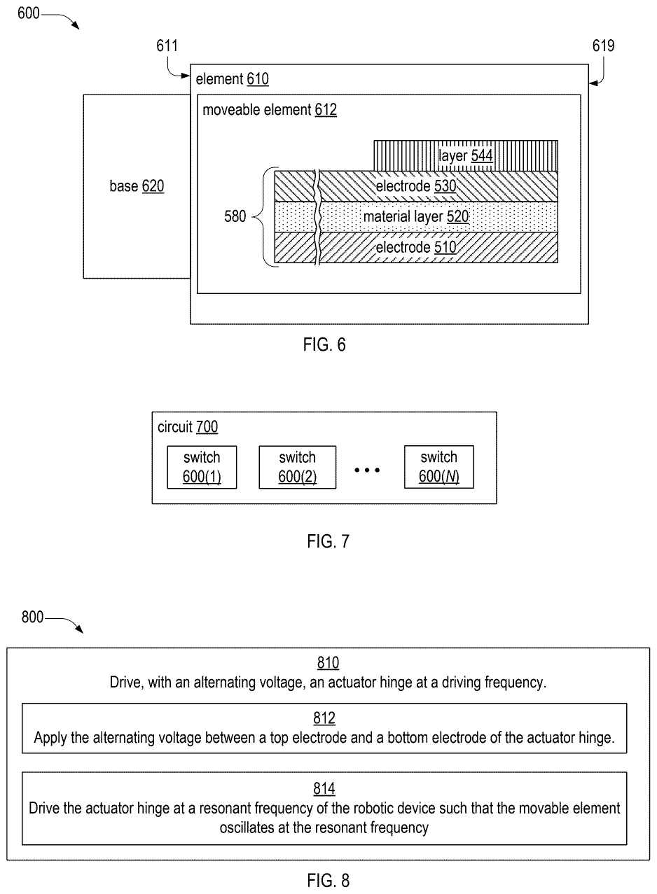

FIG. 6 is a schematic of a switch 600 that includes an element 610, a movable element 612, and actuator hinge 580. One or more switches 600 may be part of a circuit 700, shown in FIG. 7. Movable element 612 may be part of element 610 and actuator hinge 580 may be part of movable element 612, as depicted in FIG. 6. Switch 600 may include loading layer 544 disposed on one of electrodes 510 and 530 of actuator hinge 580.

In response to an applied first voltage, element 610 changes shape from a first shape to a second shape. In response to an applied second voltage, different from the applied first voltage, the element 610 changes shape from the second shape to the first shape.

Switch 600 is (i) in a first state when element 610 is configured in the first shape and (ii) in a second state when element 610 is configured in the second shape. That is, switch 600 is (i) in the first state when the shape of element 610 is the first shape and (ii) in the second state when the shape of element 610 is the second shape. The shape of element 610 may define the state of switch 600, such that the first state and the second state are defined by element 610's shape being the first shape and the second shape, respectively.

Element 610 has a fixed proximal end 611 and a free distal end 619. Switch 600 may include a base 620 to which fixed proximal end 611 is connected, such that element 610 is cantilevered at base 620. When element 610 changes shape from the first shape to the second shape, free distal end 619 subtends a first arclength. When element 610 changes shape from the second shape to the first shape, free distal end 619 subtends a second arclength.

FIG. 8 is a flowchart illustrating a method 800 for operating a robotic device, such as robotic device 500, FIG. 5. The following description of method 800 includes parenthetical numbers following terms recited by the method. The parenthetical number indicates that the element associated with the number in parentheses is an example of the term. For example, the description of step 810 below recites “an actuator hinge (580),” which means that actuator hinge 580 of FIG. 5 is an example of the actuator hinge introduced in step 810.

Method 800 includes step 810, which may include one or both of step 812 and step 814. Step 810 includes driving, with an alternating voltage, an actuator hinge (580) of the robotic device at a driving frequency. Step 812 includes applying the alternating voltage between a top electrode (530) and a bottom electrode (510) of the actuator hinge. Step 814 includes driving the actuator hinge at a resonant frequency of the robotic device such that a movable element (540) of the robotic device, connected to the actuator hinge, oscillates at the resonant frequency. The resonance frequency may be between 0.1 Hz and 10 kHz. In embodiments, alternating voltage varies between a maximum voltage and a minimum voltage, where the maximum voltage is between 0.1 and 10 volts and the minimum voltage is between −0.1 and −10 volts.

### Combinations of Features

Features described above, as well as those claimed below, may be combined in various ways without departing from the scope hereof. The following enumerated examples illustrate some possible, non-limiting combinations.

Embodiment 1. A robotic device, comprising: an actuator hinge including a bottom electrode, a top electrode, and a solid-state ionic material layer between the bottom electrode and the top electrode; and a movable element connected to the actuator hinge.

Embodiment 2. The robotic device of embodiment 1, wherein a material composition of the solid-state ionic material layer includes one of a transition metal oxide, a complex oxide, a lithium-based solid electrolyte, silver iodide, beta-alumina, rubidium silver oxide, calcium fluoride, halide-ion conductor, sodium-ion conductor, perovskite-based ionic material, or any combination thereof.

Embodiment 3. The robotic device of embodiment 2, wherein the transition metal oxide includes one of TaOₓ, HfOₓ, TiOₓ, CuOₓ, ZrOₓ, SiOₓ, AlOₓ, VOₓ, WOₓ, or any combination thereof.

Embodiment 4. The robotic device of any one of embodiments 1-3, the bottom electrode and the top electrode having a first material composition and a second material composition, respectively, each of the first and the second material composition comprising one of platinum, palladium, gold, titanium, aluminum, tantalum, chromium, nickel, copper, iron, cobalt, silver, iridium, ruthenium, molybdenum, an alloy, a conductive oxide, or any combination thereof.

Embodiment 5. The robotic device of any one of embodiments 1-4, wherein the movable element has at least one of a length between 10 and 1 mm, a width between 10 and 1 mm, and a thickness between 10 nm and 10 μm.

Embodiment 6. The robotic device of any one of embodiments 1-5, further comprising: a sensor; and circuitry configured to receive a measured signal from the sensor.

Embodiment 7. The robotic device of embodiment 6, wherein the circuitry outputs a control signal, based on the measured signal, and the actuator hinge adjusts operations and/or motion of movable element based on the control signal.

Embodiment 8. The robotic device of any one of embodiments 1-7, the movable element comprising a rigid frame and a loading layer connected to or on the rigid frame.

Embodiment 9. The robotic device of embodiment 8, further comprising a plurality of mass loads embedded within the loading layer.

Embodiment 10. A method for operating a robotic device of embodiment 1, comprising driving, with an alternating voltage, the actuator hinge at a driving frequency.

Embodiment 11. The method of embodiment 10, wherein said driving the actuator hinge comprises driving the actuator hinge at a resonant frequency of the robotic device such that the movable element oscillates at the resonant frequency.

Embodiment 12. The method of embodiment 11, wherein the resonant frequency is between 0.1 Hz and 10 kHz.

Embodiment 13. The method of any one of embodiments 10-12, wherein the alternating voltage varies between a maximum voltage and a minimum voltage, the maximum voltage being between 0.1 and 10 volts and the minimum voltage being between −0.1 and −10 volts.

Embodiment 14. A switch comprising: a first element, comprising a movable element, the movable element comprising a top thin-film electrode, a bottom thin-film electrode, and a solid-state ionic material layer between the top thin-film electrode and the bottom thin-film electrode, wherein, responsive to an applied first voltage, the first element changes shape from a first shape to a second shape and, responsive to an applied second voltage different from the applied first voltage, the first element changes shape from the second shape to the first shape; wherein the switch is in a first state when the first element is configured in the first shape, and wherein the switch is in a second state when the first element is configured in the second shape.

Embodiment 15. The switch of embodiment 14, the first element being cantilevered and having a fixed proximal end and free distal end, wherein: the distal end subtends a first arclength upon the first element changing shape from the first shape to the second shape; and the distal end subtends a second arclength upon the first element's changing shape from the second shape to the first shape.

Embodiment 16. The switch of either one of embodiments 14 and 15, wherein the solid-state ionic material layer includes one of a transition metal oxide, a complex oxide, a lithium-based solid electrolyte, silver iodide, beta-alumina, rubidium silver oxide, calcium fluoride, halide-ion conductor, sodium-ion conductor, perovskite-based ionic material, or any combination thereof.

Embodiment 17. The switch of any one of embodiments 14-16, wherein the solid-state ionic material layer has at least one of a length between 10 and 1 mm, a width between 10 and 1 mm, and a thickness between 10 nm and 10 μm.

Embodiment 18. The switch of any one of embodiments 14-17, the bottom thin-film electrode and the top thin-film electrode having a first material composition and a second material composition, respectively, each of the first and the second material composition comprising one of platinum, palladium, gold, titanium, aluminum, tantalum, chromium, nickel, copper, iron, cobalt, silver, iridium, ruthenium, molybdenum, an alloy, a conductive oxide, or any combination thereof.

Embodiment 19. The switch of any one of embodiments 14-18, further comprising a loading layer disposed on the top thin-film electrode and/or the bottom thin-film electrode.

Embodiment 20. The switch of any one of embodiments 14-18, further comprising a second element that is in a first element-state when the first element is in the first shape and in a second element-state with the first element is in the second shape. In embodiments, the first element-state and the second element-state correspond, respectively, to the switch being open and the switch being closed. In other embodiments, the first element-state and the second element-state correspond, respectively, to the switch being closed and the switch being open. Relative to the first element, the second element may be either stationary or movable.

Embodiment 21. A circuit comprising a switch of any one of embodiments 14-20.

Embodiment 22. The switch of any one of embodiments 14-20 further comprising a power source electrically connected to the first element that, upon applying a voltage across the solid-state ionic material layer, induces a curvature change of the first element that is between 0.01 μm⁻¹ and 0.05 μm⁻¹, a magnitude of the voltage being less than ten volts.

Embodiment 23 The switch of any one of embodiments 14-20 and 22, a thickness of one or more of the bottom thin-film electrode, the top thin-film electrode, and the solid-state ionic material layer being less than 100 nanometers.

Embodiment 24. The robotic device of any one of embodiments 1-8, further comprising a power source electrically connected to the actuator hinge that, upon applying a voltage across the solid-state ionic material layer, induces a curvature change of the actuator hinge that is between 0.01 μm⁻¹ and 0.05 μm⁻¹, a magnitude of the voltage being less than ten volts.

Embodiment 25. The robotic device of any one of embodiments 1-8 and 24, a thickness of one or more of the bottom electrode, the top electrode, and the solid-state ionic material layer being less than 100 nanometers.

Changes may be made in the above methods and systems without departing from the scope of the present embodiments. It should thus be noted that the matter contained in the above description or shown in the accompanying drawings should be interpreted as illustrative and not in a limiting sense. Herein, and unless otherwise indicated, the phrase “in embodiments” is equivalent to the phrase “in certain embodiments,” and does not refer to all embodiments.

As used in this specification, any appendices thereto, and the appended claims, the singular forms “a,” “an,” and “the” include plural referents unless the content clearly dictates otherwise. It should also be noted that the term “or” is generally employed in its sense including “and/or” unless the content clearly dictates otherwise. Regarding instances of the terms “and/or” and “at least one of,” for example, in the cases of “A and/or B,” “at least one of A and B,” and “at least one of A or B,” such phrasing encompasses the selection of (i) A only, or (ii) B only, or (iii) both A and B. In the cases of “A, B, and/or C,” “at least one of A, B, and C,” and “at least one of A, B, or C,” such phrasing encompasses the selection of (i) A only, or (ii) B only, or (iii) C only, or (iv) A and B only, or (v) A and C only, or (vi) B and C only, or (vii) each of A and B and C. This may be extended for as many items as are listed.

### REFERENCES

[1] W. Hu, G. Z. Lum, M. Mastrangeli, and M. Sitti, Small-scale soft-bodied robot with multimodal locomotion, Nature 554, 81 (2018).
[2] C. Li, T. Zhang, and D. I. Goldman, A terradynamics of legged locomotion on granular media, Science 339, 1408 (2013).
[3] H. Zhu, B. Xu, Y. Wang, X. Pan, Z. Qu, and Y. Mei, Self-powered locomotion of a hydrogel water strider, Science Robotics 6, eabe7925 (2021).
[4] S. Man, S. Kim, and S. Bergbreiter, The microDelta: Downscaling robot mechanisms enables ultrafast and high-precision movement, Science Robotics 10, eadx3883 (2025).
[5] F. C. Landers et al., Clinically ready magnetic microrobots for targeted therapies, Science 390, 710 (2025).
[6] P. A. York, R. Pena, D. Kent, and R. J. Wood, Microrobotic laser steering for minimally invasive surgery, Science Robotics 6, eabd5476 (2021).
[7] N. T. Jafferis, E. F. Helbling, M. Karpelson, and R. J. Wood, Untethered flight of an insect-sized flapping-wing microscale aerial vehicle, Nature 570, 491 (2019).
[8] K. Y. Ma, P. Chirarattananon, S. B. Fuller, and R. J. Wood, Controlled flight of a biologically inspired, insect-scale robot, Science 340, 603 (2013).
[9] Y. Chen, H. Zhao, J. Mao, P. Chirarattananon, E. F. Helbling, N. P. Hyun, D. R. Clarke, and R. J. Wood, Controlled flight of a microrobot powered by soft artificial muscles, Nature 575, 324 (2019).
[10] S. Palagi and P. Fischer, Bioinspired microrobots, Nature Reviews Materials 3, 113 (2018).
[11] T.-Y. Huang, H. Gu, and B. J. Nelson, Increasingly intelligent micromachines, Annual Review of Control, Robotics, and Autonomous Systems 5, 279 (2022).
[12] T. N. Theis and H.-S. P. Wong, The end of Moore's law: A new beginning for information technology, Computing in Science & Engineering 19, 41 (2017).
[13] C. E. Leiserson, N. C. Thompson, J. S. Emer, B. C. Kuszmaul, B. W. Lampson, D. Sanchez, and T. B. Schardl, There's plenty of room at the top: What will drive computer performance after Moore's law?, Science 368, eaam9744 (2020).
[14] L. Hines, K. Petersen, G. Z. Lum, and M. Sitti, Soft actuators for small-scale robotics, Advanced Materials 29, 1603483 (2017).
[15] Y. Lee, V. K. Bandari, J. S. McCaskill, P. Adluri, D. Karnaushenko, D. D. Karnaushenko, and O. G. Schmidt, Si chiplet-controlled 3D modular microrobots with smart communication in natural aqueous environments, Science Robotics 10, eadu6007 (2025).
[16] H. J. Kim, B. Chen, Z. Suo, and R. C. Hayward, Ionoelastomer junctions between polymer networks of fixed anions and cations, Science 367, 773 (2020).
[17] M. Z. Miskin, A. J. Cortese, K. Dorsey, E. P. Esposito, M. F. Reynolds, Q. Liu, M. Cao, D. A. Muller, P. L. McEuen, and I. Cohen, Electronically integrated, mass-manufactured, microscopic robots, Nature 584, 557 (2020).
[18] X. Xia, A. Afshar, H. Yang, C. M. Portela, D. M. Kochmann, C. V. Di Leo, and J. R. Greer, Electrochemically reconfigurable architected materials, Nature 573, 205 (2019).
[19] E. Smela, O. Inganas, and I. Lundström, Controlled folding of micrometer-size structures, Science 268, 1735 (1995).
[20] C. R. Knick, D. J. Sharar, A. A. Wilson, G. L. Smith, C. J. Morris, and H. A. Bruck, High frequency, low power, electrically actuated shape memory alloy MEMS bimorph thermal actuators, Journal of Micromechanics and Microengineering 29, 075005 (2019).
[21] E. Makagon, E. Wachtel, L. Houben, S. R. Cohen, Y. Li, J. Li, A. I. Frenkel, and I. Lubomirsky, All-solid-state electro-chemo-mechanical actuator operating at room temperature, Advanced Functional Materials 31, 2006712 (2021).
[22] Y. Zhu, M. Birla, K. R. Oldham, and E. T. Filipov, Elastically and plastically foldable electrothermal micro-origami for controllable and rapid shape morphing, Advanced Functional Materials 30, 2003741 (2020).
[23] W. Wang et al., Cilia metasurfaces for electronically programmable microfluidic manipulation, Nature 605, 681 (2022).
[24] M. F. Reynolds et al., Microscopic robots with onboard digital control, Science Robotics 7, eabg2296 (2022).
[25] Q. Liu et al., Electronically configurable microscopic metasheet robots, Nature Materials 24, 109 (2025).
[26] S. Ezhilvalavan and T.-Y. Tseng, Conduction mechanisms in amorphous and crystalline ta₂o₅ thin films, Journal of Applied Physics 83, 4797 (1998).
[27] Y. Liu, A. Madanchi, A. S. Anker, L. Simine, and V. L. Deringer, The amorphous state as a frontier in computational materials design, Nature Reviews Materials 10, 228 (2025).
[28] R. Hu, X. Li, J. Tang, Y. Li, X. Zheng, B. Gao, H. Qian, and H. Wu, Investigation of resistive switching mechanisms in ti/TiOx/pd-based RRAM devices, Advanced Electronic Materials 8, 2100827 (2022).
[29] J. Souquet, Ionic transport in amorphous solid electrolytes, Annual Review of Materials Science 11, 211 (1981).
[30] G. Vajente et al., Effect of elevated substrate temperature deposition on the mechanical losses in tantala thin film coatings, Classical and Quantum Gravity 35, 075001 (2018).
[31] C. Bean, J. Fisher, and D. Vermilyea, Ionic conductivity of tantalum oxide at very high fields, Physical Review 101, 551 (1956).
[32] T. Heisig, K. Lange, A. Gutsche, K. T. Goß, S. Hambsch, A. Locatelli, T. O. Mente, F. Genuzio, S. Menzel, and R. Dittmann, Chemical structure of conductive filaments in tantalum oxide memristive devices and its implications for the formation mechanism, Advanced Electronic Materials 8, 2100936 (2022).
[33] X. Wu, N. Cui, Q. Zhang, W. Wang, Q. Huang, H. Zhang, and Q. Xu, Density functional theory study of oxygen vacancy defect diffusion properties in λ-ta₂o₅, Japanese Journal of Applied Physics 59, 121003 (2020).
[34] J. Park and S. Kim, Improving endurance and reliability by optimizing the alternating voltage in pt/ZnO/TiN RRAM, Results in Physics 39, 105731 (2022).
[35] A. Pons and T. Beatus, Distinct forms of resonant optimality within insect indirect flight motors, Journal of The Royal Society Interface 19, 20220080 (2022).
[36] R. F. Gibson, Principles of Composite Material Mechanics (CRC press, 2007).
[37] Y.-N. Wu, L. Li, and H.-P. Cheng, First-principles studies of ta₂o₅ polymorphs, Physical Review B—Condensed Matter and Materials Physics 83, 144105 (2011).
[38] W. E. Newell, Miniaturization of tuning forks: Integrated electronic circuits provide the incentive and the means for orders-of-magnitude reduction in size, Science 161, 1320 (1968).
[39] R. Christian, The theory of oscillating-vane vacuum gauges, Vacuum 16, 175 (1966).
[40] B. M. Finio, N. O. Pérez-Arancibia, and R. J. Wood, System Identification and Linear Time-Invariant Modeling of an Insect-Sized Flapping-Wing Micro Air Vehicle, in 2011 IEEE/RSJ International Conference on Intelligent Robots and Systems (IEEE, 2011), pp. 1107-1114.
[41] J. Lynch, J. Gau, S. Sponberg, and N. Gravish, Dimensional analysis of spring-wing systems reveals performance metrics for resonant flapping-wing flight, Journal of the Royal Society Interface 18, 20200888 (2021).
[42] M. Piccoli and M. Yim, Piccolissimo: The Smallest Micro Aerial Vehicle, in 2017IEEE International Conference on Robotics and Automation (ICRA) (IEEE, 2017), pp. 3328-3333.
[43] C. P. Ellington, The novel aerodynamics of insect flight: Applications to micro-air vehicles, Journal of Experimental Biology 202, 3439 (1999).
[44] S. P. Sane and M. H. Dickinson, The control of flight force by a flapping wing: Lift and drag production, Journal of Experimental Biology 204, 2607 (2001).
[45] Y. Zhao, Z. Liu, P. Shi, C. Chen, Y. Alsaid, Y. Yan, and X. He, Antagonistic-contracting high-power photo-oscillators for multifunctional actuations, Nature Materials 24, 116 (2025).
[46] M. H. Dickinson and J. R. Lighton, Muscle efficiency and elastic storage in the flight motor of Drosophila, Science 268, 87 (1995).
[47] J. Li et al., Superfast-response and ultrahigh-power-density electromechanical actuators based on hierarchal carbon nanotube electrodes and chitosan, Nano Letters 11, 4636 (2011).
[48] J. Wakeling and C. Ellington, Dragonfly flight: III. Lift and power requirements, Journal of Experimental Biology 200, 583 (1997).
[49] T. Urca, A. K. Debnath, J. Stefanini, R. Gurka, and G. Ribak, The aerodynamics and power requirements of forward flapping flight in the mango stem borer beetle (batocera rufomaculata), Integrative Organismal Biology 2, obaa026 (2020).
[50] R. K. Josephson, Power output from a flight muscle of the bumblebee Bombus terrestris: III. Power during simulated flight, Journal of Experimental Biology 200, 1241 (1997).

The following claims are intended to cover all generic and specific features described herein, as well as all statements of the scope of the present method and system, which, as a matter of language, might be said to fall therebetween.

What is claimed is:

1. A robotic device, comprising:
an actuator hinge including a bottom electrode, a top electrode, and a solid-state ionic material layer between the bottom electrode and the top electrode; and
a movable element connected to the actuator hinge.

2. The robotic device of claim 1, wherein a material composition of the solid-state ionic material layer includes one of a transition metal oxide, a complex oxide, a lithium-based solid electrolyte, silver iodide, beta-alumina, rubidium silver oxide, calcium fluoride, halide-ion conductor, sodium-ion conductor, perovskite-based ionic material, or any combination thereof.

3. The robotic device of claim 2, wherein the transition metal oxide includes one of TaOₓ, HfOₓ, TiOₓ, CuOₓ, ZrOₓ, SiOₓ, AlOₓ, VOₓ, WOₓ, or any combination thereof.

4. The robotic device of claim 1, the bottom electrode and the top electrode having a first material composition and a second material composition, respectively,
each of the first and the second material composition comprising one of platinum, palladium, gold, titanium, aluminum, tantalum, chromium, nickel, copper, iron, cobalt, silver, iridium, ruthenium, molybdenum, an alloy, a conductive oxide, or any combination thereof.

5. The robotic device of claim 1, wherein the movable element has at least one of a length between 10 μm and 1 mm, a width between 10 μm and 1 mm, and a thickness between 10 nm and 10 μm.

6. The robotic device of claim 1, further comprising:
a sensor; and
circuitry configured to receive a measured signal from the sensor.

7. The robotic device of claim 6, wherein the circuitry outputs a control signal, based on the measured signal, and the actuator hinge adjusts operations and/or motion of movable element based on the control signal.

8. The robotic device of claim 1, further comprising a power source electrically connected to the actuator hinge that, upon applying a voltage across the solid-state ionic material layer, induces a curvature change of the actuator hinge that is between 0.01 μm⁻¹ and 0.05 μm⁻¹, a magnitude of the voltage being less than ten volts.

9. The robotic device of claim 1, a thickness of one or more of the bottom electrode, the top electrode, and the solid-state ionic material layer being less than 100 nanometers.

10. The robotic device of claim 1, the movable element comprising a rigid frame and a loading layer connected to or on the rigid frame.

11. The robotic device of claim 10, further comprising a plurality of mass loads embedded within the loading layer.

12. A method for operating a robotic device of claim 1, comprising driving, with an alternating voltage, the actuator hinge at a driving frequency.

13. The method of claim 12, wherein said driving the actuator hinge comprises driving the actuator hinge at a resonant frequency of the robotic device such that the movable element oscillates at the resonant frequency.

14. The method of claim 13, wherein the resonant frequency is between 0.1 Hz and 10 kHz.

15. The method of claim 12, wherein the alternating voltage varies between a maximum voltage and a minimum voltage, the maximum voltage being between 0.1 and 10 volts and the minimum voltage being between −0.1 and −10 volts.

16. A switch comprising:
a first element, comprising a movable element, the movable element comprising a top thin-film electrode, a bottom thin-film electrode, and a solid-state ionic material layer between the top thin-film electrode and the bottom thin-film electrode, wherein, responsive to an applied first voltage, the first element changes shape from a first shape to a second shape and, responsive to an applied second voltage different from the applied first voltage, the first element changes shape from the second shape to the first shape;
wherein the switch is in a first state when the first element is configured in the first shape, and wherein the switch is in a second state when the first element is configured in the second shape.

17. The switch of claim 16,
the first element being cantilevered and having a fixed proximal end and free distal end, wherein:
the distal end subtends a first arclength upon the first element changing shape from the first shape to the second shape; and
the distal end subtends a second arclength upon the first element's changing shape from the second shape to the first shape.

18. The switch of claim 16, the bottom thin-film electrode and the top thin-film electrode having a first material composition and a second material composition, respectively,
each of the first and the second material composition comprising one of platinum, palladium, gold, titanium, aluminum, tantalum, chromium, nickel, copper, iron, cobalt, silver, iridium, ruthenium, molybdenum, an alloy, a conductive oxide, or any combination thereof.

19. The switch of claim 16, further comprising a loading layer disposed on the top thin-film electrode and/or the bottom thin-film electrode.

20. A circuit comprising a switch of claim 16.
